(19) United States
(12) Patent Application Publication
(10) Pub. No.: US 2016/0024311 A1
(43) Pub. Date: Jan. 28, 2016

(54) ANTICORROSIVE AND ANTI-FATIGUE CHEMICAL COMPOSITION FOR NICKEL-TITANIUM DENTAL INSTRUMENTS AND A METHOD OF SYNTHESIZING THE SAME

(71) Applicants: Mohamad Ali Saghiri, Madison, WI (US); Nader Sheibani, Madison, WI (US); Armen Asatourian, TEHRAN (IR); Franklin Garcia-Godoy, Memphis, TN (US)

(72) Inventors: Mohamad Ali Saghiri, Madison, WI (US); Nader Sheibani, Madison, WI (US); Armen Asatourian, TEHRAN (IR); Franklin Garcia-Godoy, Memphis, TN (US)

(21) Appl. No.: 14/873,198

(22) Filed: Oct. 2, 2015

(51) Int. Cl. C09D 5/08; C08K 5/17; C08K 3/16; A61C 5/02

(52) U.S. Cl. CPC C09D 5/08; A61C 5/023; C08K 5/17; C08K 3/16

(57) ABSTRACT

The embodiments herein disclose a dental anti-corrosive and anti-fatigue chemical composition. The chemical composition stabilizes the passivating oxide layer and reduces the corrosion specifically fretting corrosion. The chemical composition is capable of increasing the fatigue resistance of NiTi rotary instruments lead to increased number of cyclic fatigue in the dental instruments. The chemical composition is synthesized by mixing sodium chloride NaCl (3.5 wt %) and 3-methoxypropylamine (MOPA) 3000 ppm solution (pH=11.1). The chemical composition is stored in carbon steel, stainless steel or aluminum. The chemical composition is applied to the NiTi rotary instruments are by 5 mL of the anticorrosive chemical composition for 24 hours. After root canal treatment and before next time usage the used instruments are cleaned and sterilized. After sterilization, the instruments are immersed inside the solution for 24 hours. After 24 hours the instruments are ready for the next treatment.

### SPONSORSHIP STATEMENT

This application is financially sponsored for international filing by the IRANIAN NATIONAL SCIENCE FOUNDATION (INSF).

### BACKGROUND

1. Technical field

The embodiments herein generally relates to the field of dental appliances or instruments. The embodiments herein particularly relate to endodontic rotary filing instruments. The embodiments herein also relate to an anticorrosive and anti-fatigue solution/chemical composition for increasing a file resistance to cyclic fatigue fracture.

2. Description of the Related Art

Endodontics is a field of dentistry, which is defined by treatments of tooth pulp and surrounding tissues in order to preserve a functional tooth. The endodontic treatment is divided into orthograde and retrograde root canal treatment, dealing with cracked teeth, and management of dental traumas. The most common treatment in this field is orthograde root canal therapy. The orthograde root canal therapy is done after a clinical diagnosis. The orthograde root canal therapy is initiated by preparing an access cavity to a dental canal and is followed by a chemo-mechanical cleaning and shaping the dental canal for obturation. During the root canal cleaning, different types of instruments are shaped and utilized to treat the patient. The main aim is preparing a thoroughly clean root canal without any remnant of the pulp tissue or microorganisms on the root canal wall, and further to shape the whole canal as tapered without any changes in apical constriction.

The endodontic instruments (including files and reamers) are used for cleaning and shaping the root canals of infected teeth. They may be in mode of either rotation or reciprocation in the canal by dentists, either manually or with the aid of a dental hand piece onto which the instruments are mounted. The instruments are generally used in sequence (depending on different root and surgery techniques) in order to achieve the desired outcome of cleaning and shaping. The endodontic instrument is subjected to a substantial cyclic bending and torsional stress as it is used in the process of cleaning and shaping a root canal. Because of the complex curvature of the root canals, a variety of unwanted procedural accidents such as ledging, transportation, perforation and instrument separation are encountered in the practice of endodontics.

The currently available endodontic rotary instruments are made of shape memory alloy (SMA) and have proven to be better in overall performance than that of stainless steel counterparts. However, the occurrence of unwanted procedural accidents is not reduced. Hence, it necessitates the new endodontic instruments with improved overall properties, especially flexibility and resistance to fracture either due to cyclic fatigue and/or torsional overload.

Many artificial devices (intracorporal devices) and implants are inserted into the human body for different purposes and for different periods of time. Many of the inserted devices are made of super elastic nickel titanium (NiTi) alloy, which undergo fatigue and eventually total failure. The failure of root canal files lead to the tooth loss.

The NiTi rotary instruments are made of pseudo elastic alloy nickel titanium (Nitinol 55). By introducing the NiTi rotary instruments, the process of cleaning and shaping the root canal and teeth has undergone many changes. The NiTi instruments are two to three times more flexible than the commonly available stainless steel files. The flexibility of NiTi instruments enable the devices to aid clinician to work on narrow and curved root canals. Beside these advantages, the root canals which are shaped by rotary instruments show minimal alterations in canal shape and also better access for irrigation that is critical for gaining excellent result in this stage.

With respect to all these benefits of NiTi instruments, there are some drawbacks such as unexpected separation of these devices, which happens without any remarkable changes in the file surface. This disastrous misshapen is mostly caused by cyclic fatigue, static and dynamic torsional fatigues. A cyclic fatigue is defined as the alternating tension/compression cycles, which occur inside the structure of an instrument when it is moving through the maximum curvature of root canal. The cyclic fatigue is mostly seen in the curved root canals. The torsional fatigue is another reason for instrument separation, which occurs in straight root canal. This type of fatigue occurs when an instrument is locked inside the canal while the engine of hand piece is trying to rotate the shank of instrument at the same time.

The dental instruments, which are made of nickel/titanium alloys (Nitinol) are rotary instruments used in the field of endodontics. It should be noted that the rotary instruments made of NiTi alloys are exposed to an especial type of corrosion named “fretting corrosion”. The fretting corrosion is the deterioration of a material that occurs at the interface of two contacting surfaces due to small oscillatory movements arising between them in the presence of a corrosive medium. The passivating oxide film of TiO₂ layer, present on titanium and its alloys, could be disrupted at very low shear stresses even by rubbing against soft tissues. The fretting and sliding wear conditions could also lead to a fracture of the passive oxide layer. In medical field, some authors have discussed about the fretting corrosion effect on crevice corrosion of modular hip tapers, where it is mentioned that it could accelerates the process of crevice corrosion. It can be presumed that fretting corrosion is an initial process which leads to crevice corrosion and finally cyclic fatigue failure occur that results in broken or separated dental instruments.

In previous studies, some authors have tried to improve fatigue resistance of NiTi rotary instruments. New manufacturing methods such as twisting method have introduced in order to increase the fatigue resistance. This method has been shown to be able to produce NiTi instruments with more resistant to fatigue when compared with other files made by traditional grinding process. The previous studies illustrated that by using thermal treatments it is possible to make metallurgical changes during annealing which might be effective for increasing fatigue resistance of NiTi rotary files.

There are several methods for surface treatment of NiTi instruments. The methods are plasma immersion ion implantation, thermal nitridation, cryogenic treatment, and electroplating.

There have been several attempts to reduce the release of NiTi without deteriorating the mechanical properties of the bulk. This has been done by the coating technologies either with titanium nitride (TiN) or with polymers. The polymer coating is not suitable for many medical devices especially orthopedic implants. On the other hand, the hard tin coatings frequently have disadvantages due to the interface between the bulk and its coating. In plasma immersion ion implantation (PIII), the specimen is placed in a chamber and immersed in the plasma. Then a highly negative pulsating voltage is applied to the sample. PHI is regularly performed to modify the surface of metals and to improve the mechanical properties such as hardness, friction-coefficient and corrosion resistance. In PHI method, the ions are extracted from plasma, accelerated, and bombarded into a device. The PHI method needs power and is costly.

The titanium nitride belongs to the refractory transition metal family and consists of both covalent and metallic bonds. The nitriding method known as powder immersion reaction assisted coating (PIRAC) produces titanium nitride (TiN) on nickel-tin alloy (NiTi). For nitriding method, the NiTi samples with a phase transform temperature at 15° C. are annealed at 900° C. for 1.5 hours, followed by 1000° C. for 1 hour in sealed container. The Nitrogen atoms diffuse into the sample and atmospheric oxygen is stopped by a steel foil consisting of a notable amount of chromium (Cr). The modified surface consists of a thin outer layer of TiN and a thicker Ti₂Ni layer underneath. This method requires high power inputs. Hence the method is costly and complex.

The cold treatment of metals during manufacturing is advocated to improve the surface hardness and thermal stability of the metal. The optimum temperature range for a cold treatment is between −60° C. and −80° C. depending on the material and other parameters involved. In the cooling approach, a cryogenic treatment (CT) involves submerging a metal in a super cooled bath containing liquid nitrogen (N) and then allowing the metal to slowly warm at room temperature. The cryogenic treatment is more effective than the cold treatment. The use of liquid nitrogen makes the process costly and complex. Furthermore, the liquid nitrogen rapidly vaporizes.

Electropolishing (EP) also known as electrochemical polishing, electrolytic polishing and reverse plating are electrochemical processes for removal of the material layer from a metallic surface. It often acts against electroplating. The instrument is immersed in a temperature controlled bath of electrolyte and serves as the anode when it is connected to the positive terminal of a direct current power supply and the negative terminal is attached to the cathode. As the current passes, the metal surface oxidizes and dissolves in electrolyte. As the cathode, a reduction reaction occurs which normally produces hydrogen. The Electrolytes used for EP are most often concentrated acid solutions with a high viscosity, such as mixtures of sulfuric/phosphoric acid. Other EP electrolytes include mixture of perchlorates with acetic anhydride and methanolic solutions of sulfuric acid. Electroplating does not inhibit development of micro fractures in endo-sequence rotary instruments. Also the use of concentrated acids and electrolytes makes the electroplating hazardous for the user.

Based on the shortcomings in the methods mentioned above, there remains a need for a treatment which is able to increase the fatigue resistance of NiTi instruments in order to prevent or delay the disastrous event of instrument separation inside root canals. Furthermore, a chemical composition is needed for treating the NiTi instruments against corrosion and fatigue.

Hence there is a need for a chemical composition for increasing the cyclic fatigue resistance of nickel-titanium (NiTi) rotary files. Also there is a need for a simple method for treating the NiTi rotary file and increasing the number of cycles of failures (NCF). Further, there is a need for a chemical composition, which is soluble in water and common organic solvents for treating the NiTi rotary files.

The above mentioned shortcomings, disadvantages and problems are addressed herein and will be understood by reading and studying the following specification.

### OBJECTIVES OF THE EMBODIMENTS

The primary objective of the embodiment herein is to provide a chemical composition, which increases a cyclic fatigue resistance and number of cycles to failure (NCF) in nickel-titanium (NiTi) rotary files.

Another object of the embodiment herein is to provide a simple method for treating the nickel-titanium (NiTi) rotary files and increasing a cyclic fatigue resistance and number of cycles to failure (NCF).

Yet another object of the embodiment herein is to provide a chemical composition which provides a fatigue resistance and corrosion resistance to the rotary files or the nickel-titanium (NiTi) dental instruments.

Yet another object of the embodiment herein is to provide a chemical composition, which is completely soluble in water and common organic solvents.

Yet another object of the embodiment herein is to provide a chemical composition, which shows an inhibitory behavior against a fretting corrosion, occurring on the surface of nickel-titanium (NiTi) instruments during rotation inside the canal.

Yet another object of the embodiment herein is to provide a chemical composition, which stabilizes the passivating oxide layer present on the surface of nickel-titanium (NiTi) rotary instruments.

These objects and the other advantages of the embodiments herein will become readily apparent from the following detailed description taken in conjunction with the accompanying drawings.

### SUMMARY

The various embodiments herein provide a chemical composition for increasing the cyclic fatigue resistance of nickel-titanium (NiTi) rotary files. A simple method is used for treating the NiTi rotary file and increasing the number of cycles of failures (NCF). Furthermore, chemical composition which is soluble in water and common organic solvents for treating the NiTi rotary files.

According to one embodiment herein, the method of synthesizing anticorrosive and anti-fatigue chemical composition for coating rotary file or nickel-titanium (NiTi) dental instruments, comprises the following steps. The first step is adding 3-methoxypropylamine (MOPA) in a preset quantity in a container. The quantity of the 3-methoxypropylamine (MOPA) is 3000 ppm or 96.5 wt %. The second step is adding sodium chloride (NaCl) in the preset quantity in the container. The quantity of the sodium chloride (NaCl) is 3.5 wt %. The third step is mixing the 3-methoxypropylamine (MOPA) and the sodium chloride (NaCl) at room temperature to obtain a mixture of the 3-methoxypropylamine (MOPA) and sodium chloride (NaCl). The mixture is an anticorrosive and anti-fatigue chemical composition applied for coating the rotary file or the nickel-titanium (NiTi) dental instruments. The chemical composition is stored in a carbon-steel container or a stainless steel container or an aluminium container.

According to one embodiment herein, the pH of the chemical composition is 11.1.

According to one embodiment herein, the method for coating rotary file or nickel-titanium (NiTi) dental instrument with anticorrosive and anti-fatigue chemical composition, comprises the following steps. The first step is immersing a rotary file or nickel-titanium (NiTi) dental instrument in 5 mL of the anticorrosive and anti-fatigue chemical composition. The second step is incubating the rotary file or nickel-titanium (NiTi) dental instrument in the 5 mL of the anticorrosive and anti-fatigue chemical composition at room temperature for 24 hours. The rotary file or nickel-titanium (NiTi) dental instrument is immersed in the chemical composition for 24 hours after a root canal treatment. The rotary file or nickel-titanium (NiTi) dental instruments are used for the root canal treatment after 24 hours. The rotary files or nickel-titanium (NiTi) dental instruments are analyzed for corrosion resistance and fatigue resistance after coating with the anticorrosive and anti-fatigue chemical composition.

According to one embodiment herein, the fatigue resistance of the rotary file or nickel-titanium (NiTi) dental instrument increases after coating with the anticorrosive and anti-fatigue chemical composition. The anticorrosive and anti-fatigue chemical compositions protect the oxide layer of the rotary file or nickel-titanium (NiTi) dental instrument and reduce fluctuation. The protection of the oxide layer increases the fatigue resistant.

According to one embodiment herein, the corrosion resistance of the rotary file or nickel-titanium (NiTi) dental instrument is increased after coating with the anticorrosive and anti-fatigue chemical composition. The anticorrosive and anti-fatigue chemical composition protects the oxide layer of the rotary file or nickel-titanium (NiTi) dental instrument and reduces fluctuation. The protection of the oxide layer increases the corrosion resistant.

According to one embodiment herein, the number of cycles of usage before a failure (NCF) of the rotary file or nickel-titanium (NiTi) dental instrument is increased after coating with the anticorrosive and anti-fatigue chemical composition.

According to one embodiment herein, the rotary file or nickel-titanium (NiTi) dental instrument has a honeycomb pattern with reduced impurity on the surface after coating with the anticorrosive and anti-fatigue chemical composition. The reduced impurity indicates the protection of the oxide layer from fretting and crevice corrosion.

According to one embodiment herein, the anticorrosive and anti-fatigue chemical composition for coating rotary file or nickel-titanium (NiTi) dental instrument comprises 3-methoxypropylamine (MOPA) in a preset quantity and sodium chloride (NaCl) in the preset quantity. The quantity of the 3-methoxypropylamine (MOPA) is 3000 ppm or 96.5 wt %. The quantity of the sodium chloride (NaCl) is 3.5 wt %. The 3-methoxypropylamine (MOPA) and the sodium chloride (NaCl) are mixed at room temperature. The chemical composition is stored in a carbon-steel container or a stainless steel container or an aluminium container.

According to one embodiment herein, the nickel-titanium (NiTi) rotary instruments are made of pseudo elastic alloy nickel titanium (Nitinol 55). By introducing the NiTi rotary instruments, the process of cleaning and shaping the root canal and teeth has undergone many changes. The NiTi instruments are two to three times more flexible than common stainless steel files. The flexibility of NiTi instruments enable the devices to aid clinician to work on narrow and curved root canals. Beside these advantages, the root canals which are shaped by rotary instruments show minimal alterations in canal shape and also better access for irrigation that is critical for gaining excellent result in this stage.

According to one embodiment herein, with respect to all these benefits of nickel-titanium (NiTi) instruments, there are some drawbacks such as unexpected separation of these devices, which happens without any remarkable changes on the file surface. This disastrous misshapen is mostly caused by cyclic fatigue, static and dynamic torsional fatigues. A cyclic fatigue is defined as the alternating tension/compression cycles which occur inside the structure of an instrument when the instrument moves through the maximum curvature of the root canal. The cyclic fatigue is mostly seen in the curved root canals. The torsional fatigue is another reason for instrument separation, occurring in straight root canal. This type of fatigue occurs when an instrument is locked inside the canal while the engine of hand piece tries to rotate the shank of instrument at the same time. Also the instruments get corroded over a period of time.

For avoiding corrosion on instruments, there are many kinds of solutions which are used in order to prevent, inhibit and minimize corrosion. Inhibitors are most commonly used. The inhibitors are classified into two categories. The first category of inhibitors that are coated on substrate and protect bulk from oxidative agents and the second type of inhibitors are migrating type corrosion inhibitors (MCI), which are usually applied during rehabilitation procedures since they diffuse into the texture and deprive oxygen from texture. These classes of inhibitors are based on mixtures of alcoholic and amines.

According to one embodiment herein, a chemical composition which is clear, colorless liquid and has ammoniacal odor is applied to inhibit corrosion. The addition of amine on the parts per million levels makes the composition effective in reducing corrosion caused by the presence of carbon dioxide and water.

Although similar compositions/solutions have been used in industrial fields as anti-corrosive solutions, but the present solution disclosed in the embodiments herein, with this specific formula, is used for the first time for dental instruments made of nickel titanium. These instruments due to their shape memory characteristic are widely used in the field of dentistry especially in endodontic treatments. Thus, this solution is used to extend the life of these instruments and decrease the possibilities of mishaps during treatments.

The anti-corrosive solution delays the cyclic fatigue and a fracture of instruments made of nickel titanium (NiTi) used inside the root canal space. The fractures of instrument inside the root canal space jeopardize the treatment outcome as in many cases the removal of broken instrument is very difficult to achieve. The possibility of the complications such as root canal treatment failure increases and provides the clinician with more challenges like performing endodontic retreatment or apical surgery, which have lesser success rate than the orthograde endodontic treatment. In some cases, the extraction of tooth and replacement with dental implant, which is very costly for the patient, is introduced as alternative treatment as well. By decreasing the possibility of fracture, the endodontic treatment mishap of broken instruments is avoided.

The anti-corrosive solution delays the fretting corrosion. The fretting corrosion is a type of corrosion that occurs as a result of oscillatory movements. During the fretting corrosion, fluctuations/variations/roughness are observed on the surface of nickel titanium (NiTi) instruments. These fluctuations/variations in smoothness/roughness represent the periodic removal (depassivation) of the passive oxide film by mechanical action and growth of the oxide film by electrochemical passivation (re-passivation) which occurs within the fretted zone.

According to one embodiment herein, the chemical composition for inhibiting the corrosion comprises 3-methoxypropyl-amine (MOPA) and sodium chloride. The formula of methoxypropylamine (MOPA) is CH₃—O—CH₂—CH₂—CH₂—NH₂.

According to one embodiment herein, methoxypropylamine (3-methoxypropyl-amine) is a clear, colorless liquid with an ammoniacal odor. The 3-methoxypropyl-amine undergoes reactions typical or primary amines and is completely soluble in water and common organic solvents. The 3-methoxypropyl-amine is used to inhibit the corrosion in stem condensate systems. The addition of the amine at parts per million levels is effective in reducing the corrosion caused by the presence of carbon dioxide in the water.

According to one embodiment herein, the chemical composition comprises of 3-methoxypropyl-amine. The 3-methoxypropyl-amine is an anti-corrosive agent or corrosion inhibitor. The rotating instruments made of nickel-titanium (NiTi) have a layer of TiO₂ on the surface which protects the instruments against corrosion. But the rotation of the instruments inside the root canal rubs off or removes or makes/causes cracks in the TiO₂ layer. This causes the breakage of the instrument. The 3-methoxypropyl-amine solution coats the surface of the instrument and preserve or stabilize the TiO₂ layer on the NiTi surface and delays the removal of the TiO₂ layer. The chemical composition prevents the nickel titanium (NiTi) alloy instruments from corrosion and fatigue. By the coating of chemical composition, the fatigue and corrosion resistance of NiTi instruments increases. Thus, the life of the NiTi instruments increases.

According to one embodiment herein, the dental nickel titanium (NiTi) alloy instrument anticorrosive chemical composition is synthesized by mixing two chemical agents. The chemical agents are sodium chloride NaCl (3.5 wt %) and methoxypropylamine (MOPA) 3000 ppm solution (pH=11.1). The anticorrosive chemical composition is stored in carbon steel, stainless steel or aluminum. The pH of the chemical composition is 11.1.

According to one embodiment herein, the method of applying the anticorrosive chemical composition on the dental nickel titanium (NiTi) alloy instrument comprises the following steps. The NiTi rotary instruments are immersed in 5 mL of the anticorrosive chemical composition for 24 hours. After root canal treatment and before next usage, the used instruments are cleaned and sterilized. After sterilization, the instruments are immersed inside the solution for 24 hours. After 24 hours the instruments are ready for the next treatment.

According to one embodiment herein, for testing the effectiveness of the anticorrosive and anti-fatigue chemical composition solution a scientific analysis is done. Following are the materials and methods for testing the anti-corrosive action of the solution:

Forty Pro Taper F1 files are selected and divided into four groups (n=10). An apparatus made of stainless steel metal is prepared for the analysis. The apparatus is an artificial dental canal. The stainless steel block is lathed by a CNC device to a 110 mm×100 mm×10 mm dimension and 63-65 stainless steel. Test canals with a total length of 16 mm, with 30° curvature angle, and 5 mm radius of curvature, are prepared. An apparatus consisting of a frame supports a hand piece and the stainless steel block with artificial canals matched for each instrument.

According to one embodiment herein, Pro Taper F1 files are first rotated at 300 rpm for 30 seconds in the presence of phosphate buffer saline (PBS) and then seven cycles of sterilization is carried out at 121° C., 15 psi pressure for 15 minutes. Thereafter, the samples are immersed in one of the following solutions (5 mL) for 24 hours in a 10 mL glass vials for 30 minutes. The solutions are classified into four groups. These are as follows. Group 1: Deionized water (DW); Group 2: blood; Group 3: PBS; and Group 4:3.5 wt % NaCl+3000 ppm methoxypropylamine (MOPA) solution (pH=11.1). The blood is collected by a vein puncture needle 25×7 in a 5 mL tube with the 5% percentage by weight anticoagulant EDTA.

According to one embodiment herein, the instruments are tested for a cyclic fatigue. Before receiving rotations, the instruments are introduced into the canals to the full working length by moving the blocks toward the fixed hand piece. All instruments are rotated at 300 rpm using a 1:16 reduction hand piece with a torque-controlled electric motor. The applied torque is 70 Nm for ProTaper, according to manufacturer's instructions. The time to fracture is recorded by a chronometer, accurate to 1:100 of a second and the number of rotations to breakage was calculated (NCF=time×speed).

According to one embodiment herein, the instruments are analyzed by a scanning electron microscope (SEM). The samples collected before sterilization, after sterilization, and also after file separation are observed by examining under a scanning electron microscope (SEM) operating at 15 kV. The data obtained is analyzed by Kolmogorov-Smirnov and ANOVA tests.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will occur to those skilled in the art from the following description of the preferred embodiment and the accompanying drawings in which:

FIG. 1 illustrates a flowchart indicating a method for synthesizing anticorrosive chemical composition for dental nickel-titanium alloy instruments, according to one embodiment herein.

FIG. 2 illustrates a flowchart indicating a method for coating nickel titanium alloy dental instruments with anticorrosive chemical composition, according to one embodiment herein.

FIG. 3 illustrates a stainless steel block lathed by CNC device to a 110 mm×100 mm×10 mm dimension including artificial canals matched for rotary instruments to testify the NCF of each instrument, according to one embodiment herein.

FIG. 4 illustrates the graph indicating number of cycles to failure (NCF) of nickel titanium (NiTi) files/dental instruments treated by anticorrosive dental chemical composition and with other solutions, according to one embodiment herein.

FIG. 5 illustrates the scanning electron microscope (SEM) images of flat parts of nickel titanium (NiTi) rotary files after sterilization and treatment with: A) Deionized water; B) Blood; C) PBS; and D) anticorrosive dental chemical composition. SEM images of the cutting edge of instruments treated with: E) blood; F) anticorrosive dental chemical composition, according to embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a chemical composition for increasing the cyclic fatigue resistance of nickel-titanium (NiTi) rotary files. A simple method is used for treating the NiTi rotary file and increasing the number of cycles of failures (NCF). Further the chemical composition which is soluble in water and common organic solvents for treating the NiTi rotary files.

According to one embodiment herein, the method of synthesizing anticorrosive and anti-fatigue chemical composition for coating rotary file or nickel-titanium (NiTi) dental instruments, comprises the following steps. 3-methoxypropylamine (MOPA) is added in a preset quantity in a container. The quantity of the 3-methoxypropylamine (MOPA) is 3000 ppm or 96.5 wt %. Then sodium chloride (NaCl) is adding in the preset quantity in the container. The quantity of the sodium chloride (NaCl) is 3.5 wt %. The 3-methoxypropylamine (MOPA) and the sodium chloride (NaCl) are mixed at room temperature to obtain a mixture of the 3-methoxypropylamine (MOPA) and the sodium chloride (NaCl). The mixture is an anticorrosive and anti-fatigue chemical composition applied for coating the rotary file or the nickel-titanium (NiTi) dental instrument. The chemical composition is stored in a carbon-steel container or a stainless steel container or an aluminium container. The pH of the chemical composition is 11.1.

According to one embodiment herein, the method for coating rotary file or nickel-titanium (NiTi) dental instrument with anticorrosive and anti-fatigue chemical composition comprises the following steps. A rotary file or nickel-titanium (NiTi) dental instrument is immersed in a 5 mL solution of the anticorrosive and anti-fatigue chemical composition, and incubated at room temperature for 24 hours. The rotary file or nickel-titanium (NiTi) dental instrument is immersed in the chemical composition solution for 24 hours after a root canal treatment. The rotary file or nickel-titanium (NiTi) dental instrument is used for the root canal treatment after 24 hours. The rotary file or nickel-titanium (NiTi) dental instruments are analyzed for corrosion resistance and fatigue resistance after coating with the anticorrosive and anti-fatigue chemical composition.

According to one embodiment herein, the fatigue resistance property of the rotary file or nickel-titanium (NiTi) dental instrument increases after coating with the anticorrosive and anti-fatigue chemical composition. The anticorrosive and anti-fatigue chemical compositions protect the oxide layer of the rotary file or nickel-titanium (NiTi) dental instrument and reduce fluctuation. The protection of the oxide layer increases the fatigue resistant.

According to one embodiment herein, the corrosion resistance property of the rotary file or nickel-titanium (NiTi) dental instrument is increased after coating with the anticorrosive and anti-fatigue chemical composition. The anticorrosive and anti-fatigue chemical composition protects the oxide layer of the rotary file or nickel-titanium (NiTi) dental instrument and reduces fluctuation. The protection of the oxide layer increases the corrosion resistant property.

According to one embodiment herein, the number of cycles of usage before a failure (NCF) of the rotary file or nickel-titanium (NiTi) dental instrument is increased after coating with the anticorrosive and anti-fatigue chemical composition.

According to one embodiment herein, the rotary file or nickel-titanium (NiTi) dental instrument has a honeycomb pattern with reduced impurity on the surface after coating with the anticorrosive and anti-fatigue chemical composition. The reduced impurity indicates the protection of the oxide layer from fretting and crevice corrosion.

According to one embodiment herein, the anticorrosive and anti-fatigue chemical composition for coating rotary file or nickel-titanium (NiTi) dental instrument comprises of the following. 3-methoxypropylamine (MOPA) in a preset quantity and sodium chloride (NaCl) in the preset quantity. The quantity of the 3-methoxypropylamine (MOPA) is 3000 ppm or 96.5 wt %. The quantity of the sodium chloride (NaCl) is 3.5 wt %. The 3-methoxypropylamine (MOPA) and the sodium chloride (NaCl) are mixed at a room temperature. The chemical composition is stored in a carbon-steel container or stainless steel container, or an aluminum container.

According to one embodiment herein, the nickel-titanium (NiTi) rotary instruments are made of pseudo elastic alloy nickel titanium (Nitinol 55). By introducing the NiTi rotary instruments, the process of cleaning and shaping the root canal and teeth has undergone many changes. The NiTi instruments are two to three times more flexible than common stainless steel files. The flexibility of NiTi instruments enable the devices to aid clinician to work on narrow and curved root canals. Beside these advantages, the root canals which are shaped by rotary instruments show minimal alterations in canal shape and also better access for irrigation that is critical for gaining excellent result in this stage.

According to one embodiment herein, with respect to all these benefits of nickel-titanium (NiTi) instruments, there are some drawbacks such as unexpected separation of these devices which occurs without any

remarkable changes on the file surface. This disastrous misshapen is mostly caused by cyclic fatigue, static and dynamic torsional fatigues. Cyclic fatigue is defined as the alternating tension/compression cycles which occur inside the structure of an instrument when it is moving through the maximum curvature of root canal. Cyclic fatigue is mostly seen in curved root canals. The torsional fatigue is another reason for instrument separation, occurring in straight root canals. This type of fatigue occurs when an instrument is locked inside the canal while the engine of hand piece is trying to rotate the shank of instrument at the same time. Also the instrument gets corroded over a period of time.

To avoid corrosion on instruments there are many kinds of solutions which are used in order to prevent, inhibit and minimize corrosion. Inhibitors are most commonly used. These inhibitors are classified into two

categories: 1) inhibitors that are coated on the substrate and protect bulk from oxidative agents, and 2) migrating corrosion inhibitors (MCI) that are usually applied during rehabilitation procedures since they diffuse into the texture and deprive oxygen from texture. These classes of inhibitors are based on mixtures of alcohols and amines.

According to one embodiment herein, a chemical composition which is clear, colorless liquid and has ammoniacal odor is developed. The chemical composition is applied to inhibit corrosion. The addition of amine at parts per million levels makes the composition effective in reducing corrosion caused by the presence of carbon dioxide and water.

Although similar compositions/solutions have been used in industrial fields as anti-corrosive solutions, the proposed solution with this specific formula is for the first time that is used for dental instruments made of nickel titanium. These instruments due to their shape memory characteristic are widely used in the field of dentistry especially in endodontic treatments. Thus, this solution can extend the life of these instruments and decrease the possibilities of mishaps during treatments.

This anti-corrosive solution can delay the cyclic fatigue and fracture of instruments made of nickel titanium (NiTi) used inside the root canal space. The fractures of instrument inside the root canal space jeopardize the treatment outcome as in many cases the removal of broken instrument is very difficult to achieve. The possibility of the complications such as root canal treatment failure can increase and face the clinician with more challenges like performing endodontic retreatment or apical surgery, which have lesser success rate than the orthograde endodontic treatment. In some cases the extraction of tooth and replacement with dental implant, which is very costly to the patient, can be introduced as alternative treatment as well. By decreasing the possibility of fracture, the endodontic treatment mishap like broken instruments is avoided.

The anti-corrosive solution delays fretting corrosion. The fretting corrosion is a type of corrosion that occurs as a result of oscillatory movements. During the fretting corrosion fluctuations are observed on the surface of nickel titanium (NiTi) instruments. These fluctuations represent the periodic removal (depassivation) of the passive oxide film by mechanical action and growth of the oxide film by electrochemical passivation (repassivation) which occurs within the fretted zone.

According to one embodiment herein, the chemical composition for inhibiting corrosion comprises 3-methoxypropyl-amine (MOPA) and sodium chloride.

According to one embodiment herein, methoxypropylamine (3-methoxypropyl-amine) is a clear, colorless liquid with an ammoniacal odor. The 3-methoxypropyl-amine undergoes reactions typical or primary amines and is completely soluble in water and common organic solvents. The 3-methoxypropyl-amine is used to inhibit corrosion in stem condensate systems. The addition of the amine at parts per million levels is effective in reducing corrosion caused by the presence of carbon dioxide in the water.

According to one embodiment herein, the chemical composition comprises of 3-methoxypropyl-amine. The 3-methoxypropyl-amine is an anti-corrosive agent or corrosion inhibitor. The rotating instruments made of nickel-titanium (NiTi) have a layer of TiO₂ on the surface which protects the instruments against corrosion, but the rotating inside the root canal rub off or removes or makes cracks in the TiO₂ layer. This causes the breakage of the instrument. The 3-methoxypropyl-amine solution coats the surface of the instrument and preserve or stabilize the TiO₂ layer on the NiTi surface and delays the removal of the TiO₂ layer. The chemical composition prevents the nickel titanium (NiTi) alloy instruments from corrosion and fatigue. By the coating of chemical composition the fatigue and corrosion resistance of NiTi instruments increases. Thus, the life of the NiTi instruments increases.

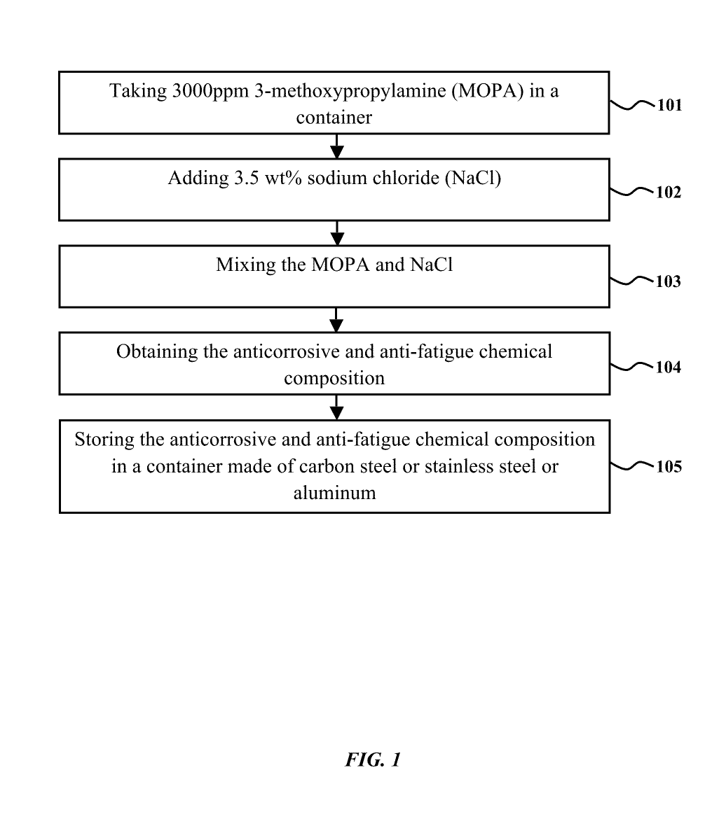

FIG. 1 illustrates a flowchart indicating a method for synthesizing anticorrosive chemical composition for dental nickel-titanium alloy instruments, according to one embodiment herein. The first step is taking 3000 ppm of 3-methoxypropylamine (MOPA) in a container (101). The second step is adding 3.5 wt % of sodium chloride (NaCl) (102). The third step is mixing MOPA and NaCl (103). The fourth step is obtaining the anticorrosive and anti-fatigue chemical composition (104). The fifth step is storing the anticorrosive and anti-fatigue chemical composition in a container made of carbon steel or stainless steel or aluminum (105). The pH of the chemical composition is 11.1.

According to one embodiment herein, the dental nickel titanium (NiTi) alloy instrument anticorrosive chemical composition is synthesized by mixing two chemical agents. The chemical agents are sodium chloride NaCl (3.5 wt %) and methoxypropylamine (MOPA) 3000 ppm solution (pH=11.1). The anticorrosive chemical composition is stored in carbon steel, stainless steel or aluminum.

According to one embodiment herein, the dental nickel titanium (NiTi) alloy instrument anticorrosive chemical composition is prepared with the 3000 ppm or 96.5 wt % methoxypropylamine (MOPA) with 3.5 wt % sodium chloride (NaCl). The formula of methoxypropylamine (MOPA) is CH₃—O—CH₂—CH₂—CH₂—NH₂.

TABLE 1 below illustrates the details of the composition:

| Composition | Molecular Formula | Percentage |
|---|---|---|
| 3-methoxypropyl-amine | C4H11NO | 96.5 |
| Sodium chloride | NaCl | 3.5 |

For handling and storage the 3-methoxypropylamine (MOPA) carbon steel, stainless steel and aluminum is used. TABLE 2 below illustrates the physical properties of methoxypropylamine (MOPA):

| | | | |
|---|---|---|---|
| Boiling point, | 116° C. | Refractive index, n²⁰ | 1.4180 |
| ° C. (° F.) | (240° F.) | | |
| Flash point, TCC, | 27° C. | Specific Gravity | 0.87 |
| ° C. (° F.) | (81° F.) | | |
| Freezing point, | −76° C. | Surface tension, | 27.64 at 25° C. |
| ° C. (° F.) | (−104° F.) | dynes/cm² | |
| Ionization constant, K_{b} | 1.3 × 10⁻⁴ | Vapor pressure, mm | 6 mm Hg at |
| | at 25° C. | Hg | 20° C. (68° F.) |
| Ionization constant, pK_{b} | 3.9 | Viscosity, cSt | 0.8 at 37.8° C. |
| | | | (100° F.) |
| Molecular weight | 89.14 | Water solubility | >10 |
| pH | 11 | | |

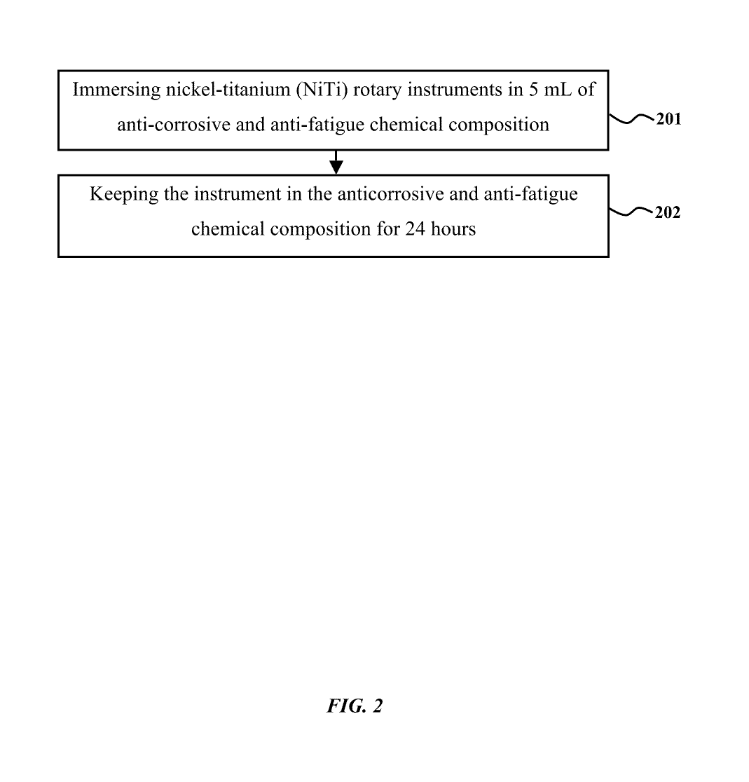

FIG. 2 illustrates a flowchart indicating a method for coating nickel titanium alloy dental instruments with anticorrosive chemical composition, according to one embodiment herein. The first step is immersing nickel-titanium (NiTi) rotary instruments in 5 mL of anti-corrosive and anti-fatigue chemical composition (201). The second step is keeping the instrument in the anticorrosion and anti-fatigue chemical composition for 24 hours (202).

According to one embodiment herein, the method of applying the anticorrosive chemical composition on the dental nickel titanium (NiTi) alloy instrument comprises the following steps. The NiTi rotary instruments are immersed in 5 mL of the anticorrosive chemical composition for 24 hours. After root canal treatment and before next time usage the used instruments are cleaned and sterilized. After sterilization, the instruments are immersed inside the solution for 24 hours. After 24 hours the instruments are ready for the next treatment.

For testing the effectiveness of the anticorrosive and anti-fatigue chemical composition solution a scientific analysis is done. Following are the materials and methods for testing the anti-corrosive action of the solution:

### MATERIALS AND METHODS

### Example 1

### Sample Treatment and Cyclic Fatigue Testing with Anticorrosive Chemical Composition

Forty Pro Taper F1 rotary files were selected and divided into four groups (n=10). All Pro Taper F1 rotary files were rotated at 300 rpm for 30 seconds using a 1:16 reduction handpiece with a torque-controlled electric motor at 300 rpm. The applied torque was 70 Nm for ProTaper, according to manufacturer's instructions. The time to fracture was recorded by a chronometer accurate to 1:100 of a second and the number of rotations to breakage was calculated (NCF=time×speed). Before and after sterilization and also after file separation. The files were observed and examined under a scanning electron microscope (SEM) operating at 15 kV.

The Pro Taper F1 rotary files were firstly rotated at 300 rpm for 30 seconds in presence of phosphate buffer saline (PBS) inside artificial canal which was made of stainless steel block lathed by a CNC device to a 110 mm×100 mm×10 mm dimension. The rotary files were subjected to seven cycles of sterilization in 121° C., 15 psi for 15 minutes. Thereafter these files were subjected to anticorrosive chemical composition in a container for 24 hours. The container has 3.5 wt % NaCl+3000 ppm methoxypropylamine (MOPA) solution (pH=11.1).

An apparatus or artificial canal is made of stainless steel metal was prepared for this study, which served as artificial dental canal. This stainless steel block was lathed by a CNC device to a 110 mm×100 mm×10 mm dimension and 63-65 Rockwell hardened stainless steel block. Test canals with a total length of 16 mm, with 30° curvature angle, and 5 mm radius of curvature, was prepared. The apparatus consisted of a frame that supported a hand piece and the stainless steel block with artificial canals matched for each instrument.

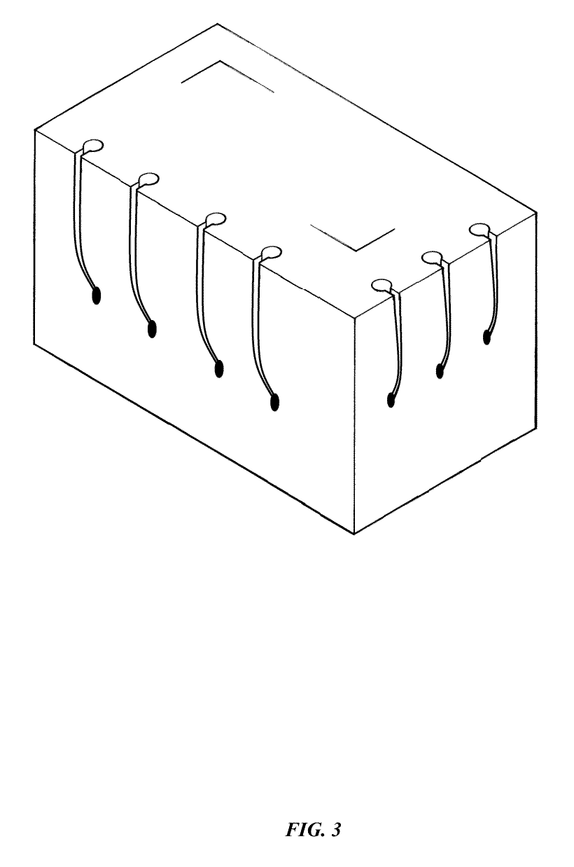

FIG. 3 illustrates a stainless steel block lathed by CNC device to a 110 mm×100 mm×10 mm dimension including artificial canals matched for rotary instruments to testify the NCF of each instrument, according to one embodiment herein. Forty Pro Taper F1 files are selected and divided into four groups (n=10). An apparatus made of stainless steel metal is prepared for the analysis. The apparatus is an artificial dental canal. The stainless steel block is lathed by a CNC device to a 110 mm×100 mm×10 mm dimension and 63-65 stainless steel. Test canals with a total length of 16 mm, with 30° curvature angle, and 5 mm radius of curvature, are prepared. An apparatus consisting of a frame supports a hand piece and the stainless steel block with artificial canals matched for each instrument.

### Example 2

### Sample Treatment and Cyclic Fatigue Testing and Comparison with Different Solutions

Pro Taper F1 files were first rotated at 300 rpm for 30seconds in the presence of PBS and then underwent seven cycles of sterilization at 121° C., 15 psi for 15 minutes. Thereafter, samples were immersed in one of the following solutions (5 mL) for 24 hours in a 10 mL glass vials for 30 minutes. Group 1: Deionized water (DW); Group 2: blood; Group 3: PBS; and Group 4:3.5 wt % NaCl+3000 ppm methoxypropylamine (MOPA) solution (pH=11.1). Blood was collected by a vein puncture needle 25×7 in a 5 mL tube with the 5% percentage by weight anticoagulant EDTA.

Before receiving rotations, the instruments were introduced into the canals to the full working length by moving the blocks toward the fixed hand piece. All instruments were rotated at 300 rpm using a 1:16 reduction handpiece with a torque-controlled electric motor. The applied torque was 70 Nm for ProTaper, according to manufacturer's instructions. The time to fracture was recorded by a chronometer, accurate to 1:100 of a second and the number of rotations to breakage was calculated (NCF=time×speed).

### Example 3

### Scanning Electron Microscope (SEM) Analysis

Samples before and after sterilization and also after file separation were observed by examining under a scanning electron microscope (SEM) operating at 15 kV. Data were analyzed by Kolmogorov-Smirnov test, Levene test, ANOVA test and Scheffe test.

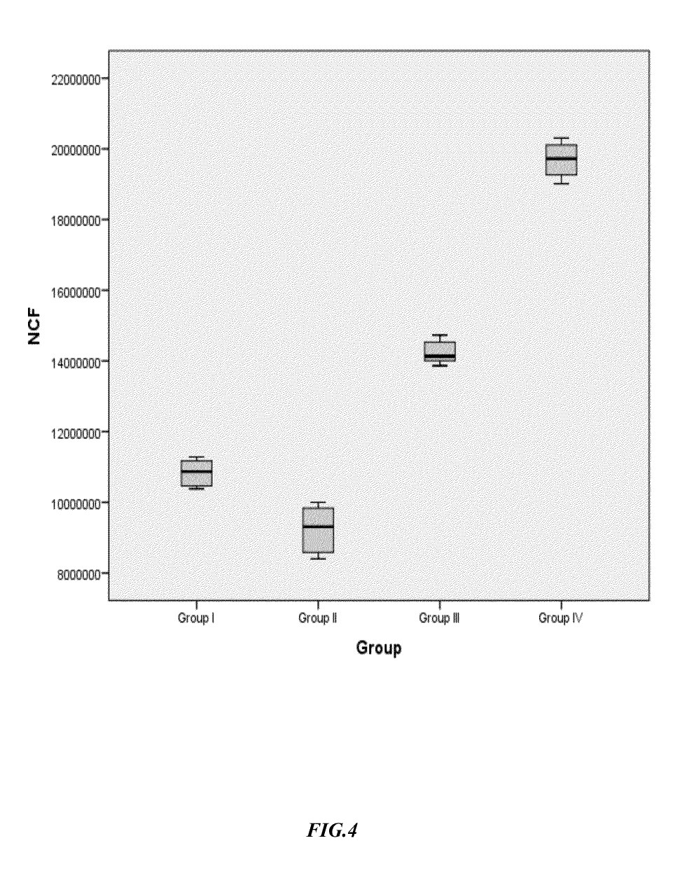

FIG. 4 illustrates the graph indicating number of cycles to failure (NCF) of nickel titanium (NiTi) files/dental instruments treated by anticorrosive dental chemical composition and with other solutions, according to one embodiment herein. The graph illustrates the number of cycles to failure (NCF) of nickel titanium (NiTi) rotary files treated by anticorrosive dental chemical composition (group 4) which is compared with other solutions such as deionized water (group 1), blood (group 2) and PBS (group 3). The image revealed the lowest NCF for group 2 (blood) and the highest NCF for group 4(Anticorrosive dental composition).

FIG. 4 illustrates the results of number of cyclic fatigue (NCF) data in MOPA treated instruments demonstrating that the fatigue resistance of rotary files has been increased. This issue is explained by the anticorrosive behavior of MOPA due to the effect of this substance on the oxide layer present at the surface of instrument. It seems that MOPA by protecting the oxide layer from depassivation reduce the fluctuations. This phenomenon results in reduction of fretting corrosion and finally affect on the NiTi file corrosion fatigue resistance.

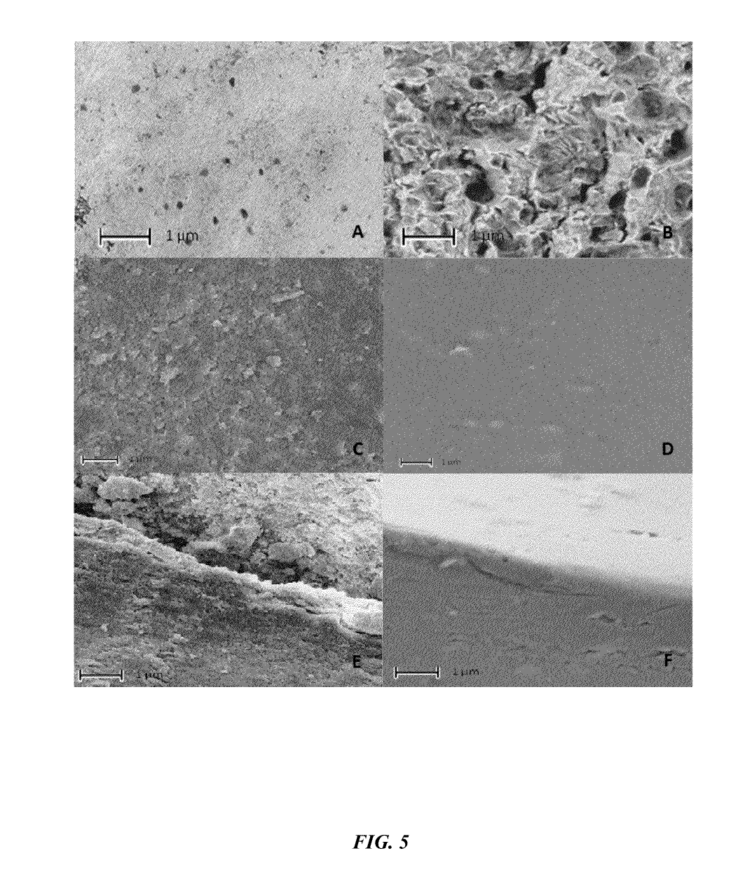

FIG. 5 illustrates the scanning electron microscope (SEM) images of flat parts of nickel titanium (NiTi) rotary files after sterilization and treatment with: A) Deionized water; B) Blood; C) PBS; and D) anticorrosive dental chemical composition and SEM images of the cutting edge of instruments treated with: E) blood; F) anticorrosive dental chemical composition, according to an embodiment herein.

FIG. 5D, 5F illustrates the SEM images showing lesser impurities, which are evident for the protection of oxide layer from fretting and crevice corrosion. The scanning electron microscope (SEM) images of rotary files after sterilization cycles, which are treated by anticorrosive dental chemical composition indicated that specimens (rotary files or nickel titanium dental instruments) revealed more regular pattern with lesser impurities (D, F) compared with the NiTi files treated with blood that show more irregular and granular pattern at the cutting edge and flat part.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A method of synthesizing anticorrosive and anti-fatigue chemical composition for coating rotary file or nickel-titanium (NiTi) dental instrument, the method comprises the steps of:
adding a 3-methoxypropylamine (MOPA) in a preset quantity in a container, and wherein the quantity of the 3-methoxypropylamine (MOPA) is 3000 ppm or 96.5 wt %;
adding a sodium chloride (NaCl) in the preset quantity in the container, and wherein the quantity of the sodium chloride (NaCl) is 3.5 wt %;
mixing the 3-methoxypropylamine (MOPA) and the sodium chloride (NaCl) at a room temperature to obtain a mixture of the 3-methoxypropylamine (MOPA) and the sodium chloride (NaCl), and wherein the mixture is an anticorrosive and anti-fatigue chemical composition applied for coating the rotary file or the nickel-titanium (NiTi) dental instrument; and
storing the chemical composition in a carbon-steel container or a stainless steel container or an aluminium container.

2. The method according to claim 1, wherein the pH of the chemical composition is 11.1.

3. A method for coating rotary file or nickel-titanium (NiTi) dental instrument with anticorrosive and anti-fatigue chemical composition, the method comprises the steps of:
immersing a rotary file or nickel-titanium (NiTi) dental instrument in a 5 mL solution of the anticorrosive and anti-fatigue chemical composition; and
incubating the rotary file or nickel-titanium (NiTi) dental instrument in the 5 mL solution of the anticorrosive and anti-fatigue chemical composition at a room temperature for 24 hours; and
wherein the rotary file or nickel-titanium (NiTi) dental instrument is immersed in the chemical composition solution for 24 hours after a root canal treatment, and wherein rotary file or nickel-titanium (NiTi) dental instrument are used for the root canal treatment after 24 hours, and wherein the rotary file or nickel-titanium (NiTi) dental instrument are analyzed for corrosion resistance and fatigue resistance after coating with the anticorrosive and anti-fatigue chemical composition.

4. The method according to claim 3, wherein the fatigue resistance of the rotary file or nickel-titanium (NiTi) dental instrument is increased after coating the rotary file or nickel-titanium (NiTi) dental instrument with the anticorrosive and anti-fatigue chemical composition, and wherein the anticorrosive and anti-fatigue chemical composition protects an oxide layer of the rotary file or nickel-titanium (NiTi) dental instrument and reduce fluctuations or variations in smoothness of surface, and wherein a protection of the oxide layer increases the fatigue resistant.

5. The method according to claim 3, wherein the corrosion resistance of the rotary file or nickel-titanium (NiTi) dental instrument is increased after coating the rotary file or nickel-titanium (NiTi) dental instrument with the anticorrosive and anti-fatigue chemical composition, and wherein the anticorrosive and anti-fatigue chemical composition protects the oxide layer of the rotary file or nickel-titanium (NiTi) dental instrument and reduce fluctuations or variations in smoothness of surface, and wherein protection of the oxide layer increases the corrosion resistant.

6. The method according to claim 3, wherein number of cycles of usage before a failure (NCF) of the rotary file or nickel-titanium (NiTi) dental instrument is increased after coating with the anticorrosive and anti-fatigue chemical composition.

7. The method according to claim 3, wherein the rotary file or nickel-titanium (NiTi) dental instrument has a honeycomb pattern and wherein an impurity on the surface of the rotary file or nickel-titanium (NiTi) dental instrument is reduced after coating the rotary file or nickel-titanium (NiTi) dental instrument with the anticorrosive and anti-fatigue chemical composition, and wherein the reduced impurity indicates a protection of the oxide layer from a fretting and a crevice corrosion.

8. An anticorrosive and anti-fatigue chemical composition for coating rotary file or nickel-titanium (NiTi) dental instrument, the composition comprises:
a 3-methoxypropylamine (MOPA) in a preset quantity, and wherein the quantity of the 3-methoxypropylamine (MOPA) is 3000 ppm or 96.5 wt %; and
a sodium chloride (NaCl) in the preset quantity, and wherein the quantity of the sodium chloride (NaCl) is 3.5 wt %.

9. The composition according to claim 8, wherein the 3-methoxypropylamine (MOPA) and the sodium chloride (NaCl) are mixed at a room temperature.

10. The composition according to claim 8, wherein the chemical composition is stored in a carbon-steel container or a stainless steel container or an aluminium container.

11. The composition according to claim 8, wherein a pH of the chemical composition is 11.1.
